(19) United States
(12) Patent Application Publication
(10) Pub. No.: US 2025/0051521 A1
(43) Pub. Date: Feb. 13, 2025

(54) AMINE-FUNCTIONALIZED POLY(ARYLENE SULFIDE) POLYMER

(71) Applicant: Solvay Specialty Polymers USA, LLC, Alpharetta, GA (US)

(72) Inventors: Matthew NIELSEN, Alpharetta, GA (US); Bryan BENSON, Ball Ground, GA (US); Hannah BROADBENT, Cumming, GA (US)

(21) Appl. No.: 18/851,132

(22) PCT Filed: Apr. 4, 2023
(86) PCT No.: PCT/EP2023/058758

§ 371 Date: Sep. 26, 2024

Related U.S. Application Data
(60) Provisional application No. 63/335,254, filed on Apr. 27, 2022.

(51) Int. Cl. C08G 75/0222; C08G 75/0254; C08L 81/02

(52) U.S. Cl. CPC C08G 75/0222; C08L 81/02; C08G 75/0254

(57) ABSTRACT

The present invention relates to certain amine-functionalized polyarylsulfide polymers possessing an advantageous compromise of properties, i.e. a molecular weight such to ensure adequate mechanical properties, a sufficient amine functionalization for appropriate reactivity towards epoxies, and a melting point not exceeding about 260° C., for enabling reaction in the molten state in liquid epoxies during curing thereof; to a method for the manufacture thereof, and to the use thereof for coating applications.

### REFERENCE TO RELATED APPLICATION

This application claims priority to US provisional application filed on 27 Apr. 2022 with No. 63/335,254, the whole content of this application being incorporated herein by reference for all purposes.

### TECHNICAL FIELD

The present invention relates to an amine functionalized poly(arylene sulfide) polymer, to a process for its manufacturing and to a composition comprising said polymer, and to the use of the said composition for coating, in particular a thermally and chemically resistant coating for use in chemical process piping or in the oil and gas domain.

### BACKGROUND ART

Poly(arylene sulfide) (PAS) polymers, including polyphenylene sulfide (PPS) polymers, are well known polymers having excellent properties suitable for engineering plastics, for instance thermal resistance, chemical resistance, electrical insulation, moldability, and mechanical properties.

PPS, a typical PAS, is a crystalline polymer having T_{g} of from 85° C. to 100° C. and a melting temperature (Tₘ) of from 275° C. to 290° C. PPS polymer is generally formed by reaction of sodium sulfide (Na₂S) or sodium hydrosulfide (NaSH) with p-dichlorobenzene in a polar solvent.

Amine-functionalized PAS polymers, i.e. PAS containing at least one amine as terminal group or side-groups in the main chain are also known, and have been recommended for various functionalities and advantageous attributes, in particular in connection with their ability to bond to impact modifiers, to adhesives or to fillers.

Methods of introducing amine groups into a PAS copolymer by copolymerizing a dihaloraromatic compound with a dichloroaniline are known, notably from JP3599124 and JP3779336.

In these documents, dihaloaromatic compound is preferably p-dichlorobenzene, so leading to a PPS-type of poly(arylene sulphide), although minor amounts (up to 20% moles) of additional dihaloaromatic compounds are taught as being possibly tolerated, including notably m-dichlorobenzene and o-dichlorobenzene.

PASs are endowed with thermal and chemical resistance, which may them particularly desirable for being used in applications exposing the same to hydrocarbon fluids, in particular at high temperature, such as for transporting corrosive fluids in the chemical processing piping; and for transportation of oil and gas, as in exploitation of deep reservoirs.

Certain classes of coatings which are used in the chemical industry and/or in the oil & gas recovery, for example coatings based on fusion bonded epoxies, have cure temperatures that do not exceed 260° C. As said, PAS may bring valuable attributes to such coatings; yet, to incorporate PAS into such curing coatings, the PAS would need both reactive functionality (such as amines) and a melt temperature below 260° C. A PAS simultaneously possessing such advantageous features would be in the molten state at the curing temperatures, i.e. in a state facilitating intermingling and blending, and would possibly react, so forming a chemically-bound interpenetrated network with the host polymer matrix of the coating.

There is hence a need in the art for PAS polymers possessing such compromise of properties, i.e. a molecular weight such to ensure adequate mechanical properties, a sufficient amine functionalization for appropriate reactivity towards epoxies, and a melting point not exceeding about 260° C., for enabling reaction in the molten state in liquid epoxies during curing thereof.

Further, there is a need in the art for a method of making such PAS polymers in an effective and simple manner, providing access to polymers with significant amine functionalization while avoiding post-functionalization tedious techniques.

### SUMMARY OF INVENTION

In a first aspect, the present invention relates to a poly(arylene sulfide) polymer [polymer (PAS)] having a weight-averaged molecular weight, as determined by gel-permeation chromatography, of at least 24,000, said polymer (PAS) comprising:
recurring units (R_{PAsp}) represented by the following formula:

[—Arₚ—S—] (R_{PAsp})

wherein

### —Arₚ— is

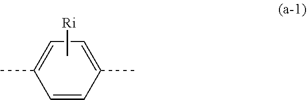

in an amount of 85.0 to 97.0% moles;
recurring units (R_{PASo/m}) represented by the following formula:

[—Ar_{o/m}—S—] (R_{PASo/m})

wherein

### —Ar_{p/m}— is any of

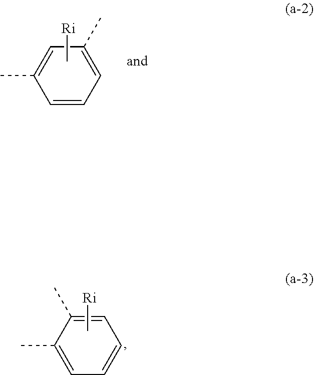

in an amount of 2.5 to 10.0% moles; and
recurring units (R_{PASn}) represented by the following formula:

[—Arₙ—S—] (R_{PASn})

wherein

### —Arₙ— is

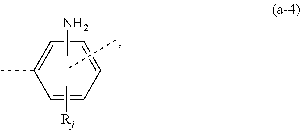

in an amount of 0.5 to 5.0% moles,
wherein:
% moles are determined with respect to the overall moles of recurring units of polymer (PAS);
R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group;
i, at each instance, is an independently selected integer from 0 to 4;
j, at each instance, is an independently selected integer from 0 to 3.

In all formulae (a1) to (a4) above, the dashed bond symbol ( . . . ) is used to designate the connection to the sulphur atom connecting to the adjacent recurring unit.

The polymer (PAS) of the invention advantageously possess a combination of attributes making the same suitable for use in combination with fusion bonded epoxies, i.e. good mechanical properties, high reactivity, and low melting point, in particular ability to reach molten state at curing temperature of fusion bonded epoxies (Tₘ of lower than about 260° C.).

In a second aspect, the present invention relates to a method for the manufacture of a poly(arylene sulfide) polymer, in particular for the manufacture of polymer (PAS), as detailed above, said method comprising reacting, in the presence of at least one sulfur compound [compound (SC)], a monomer mixture comprising:
from 85.0 to 97.0% moles of at least one first dihalo-compound of formula X—Arₚ—X′, where —Arₚ— is

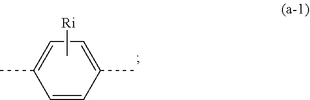

from 2.5 to 10.0% moles of at least one second dihalo-compound of formula: X″—Ar_{o/m}—X′″, where —Ar_{o/m}— is any of

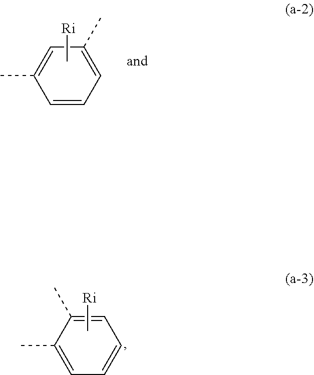

from 2.5 to 5.0% moles of at least one third dihalo-compound of formula: X′^{v}—Arₙ—X^{v}, where —Arₙ— is

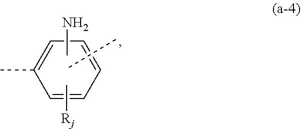

wherein:
each of X, X′, X″, X′″, X′^{v}, and X^{v}, is an independently selected halogen, preferably chlorine or bromine, more preferably chlorine;
R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group;
i, at each instance, is an independently selected integer from 0 to 4;
j, at each instance, is an independently selected integer from 0 to 3.

In a third aspect, the present invention relates to a composition (C) comprising:
the polymer (PAS), as described above, and
at least one epoxy resin.

The Applicant has found that by combining in polymer (PAS), as above detailed, recurring units (R_{PASp}), recurring units (R_{PASo/m}) and recurring units (R_{PASn}), in the above specified respective amounts, it is possible to achieve the optimal balance of performances, including adequate functionalization, acceptable molecular weight range and moderate melting point, facilitating melting-in of polymer (PAS) in different curable coating applications.

### DISCLOSURE OF THE INVENTION

In the present application, any description, even though described in relation to a specific embodiment, is applicable to and interchangeable with other embodiments of the present disclosure.

In the present application, where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list.

In the present application, any recitation herein of numerical ranges by endpoints includes all numbers subsumed within the recited ranges as well as the endpoints of the range and equivalents.

### Poly(Arylene Sulfide) Polymer [Polymer (PAS)]

As said, poly(arylene sulfide) polymer [polymer (PAS)] comprises:
recurring units (R_{PASp}) in an amount of 85.0 to 97.0% moles;
recurring units (R_{PASo/m}) in an amount of 2.5 to 10.0% moles; and
recurring units (R_{PASn}) in an amount of 0.5 to 5.0% moles,
   where % moles are determined with respect to the overall moles of recurring units of polymer (PAS).

When the amount of recurring units (R_{PASo/m}) is below 2.5% moles, the polymer (PAS) would not be optimized, in particular in that the melting point would be too high for polymer (PAS) of being of usefulness in certain curable coating compositions, e.g. in fused epoxies solutions.

On the other side, an amount of recurring units (R_{PASo/m}) exceeding 10.0% moles would detrimentally affect the ability for polymer (PAS) of achieving reasonable molecular weight, so jeopardizing generally mechanical properties' performances.

Polymer (PAS) may further comprise recurring units (R_{PASt}) of formula:

[—Arₜ—S—] (R_{PASt})
where —Arₜ— is

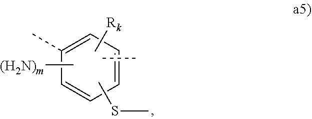

wherein:
R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group;
k, at each instance, is an independently selected integer from 0 to 3;
m, at each instance, is either 1 or zero.

In formula a5), the bond symbol [symbol] is intended to designate a polymeric chain comprising a sequence of recurring units (R_{PASp}), (R_{PASo/m}), and/or (R_{PASn}).

Hence, the polymer (PAS) of the invention comprises:
recurring units (R_{PAsp}) in an amount of 85.0 to 97.0% moles;
recurring units (R_{PASo/m}) in an amount of 2.5 to 10.0% moles;
recurring units (R_{PASn}) in an amount of 0.5 to 5.0% moles; and,
optionally, recurring units (R_{PASt}) in an amount of zero to 3.0% moles where % moles are determined with respect to the overall moles of recurring units of polymer (PAS).

Preferably, the polymer (PAS) of the invention comprises:
recurring units (R_{PAsp}) in an amount of 88.0 to 96.0% moles;
recurring units (R_{PASo/m}) in an amount of 3.0 to 8.0% moles;
recurring units (R_{PASn}) in an amount of 1.0 to 4.0% moles; and,
optionally, recurring units (R_{PASt}) in an amount of zero to 2.0% moles, where % moles are determined with respect to the overall moles of recurring units of polymer (PAS).

More preferably, the polymer (PAS) of the invention comprises:
recurring units (R_{PAsp}) in an amount of 89.0 to 94.5% moles;
recurring units (R_{PASo/m}) in an amount of 4.0 to 7.5% moles;
recurring units (R_{PASn}) in an amount of 1.5 to 3.5% moles; and,
optionally, recurring units (R_{PASt}) in an amount of zero to 1.5% moles, where % moles are determined with respect to the overall moles of recurring units of polymer (PAS).

According to certain embodiments, polymer (PAS) actually comprises recurring units (R_{PASt}).

According to these embodiments, the polymer (PAS) of the invention comprises:
recurring units (R_{PASp}) in an amount of 85.0 to 96.8% moles;
recurring units (R_{PASo/m}) in an amount of 2.5 to 10.0% moles;
recurring units (R_{PASn}) in an amount of 0.5 to 5.0% moles; and,
recurring units (R_{PASt}) in an amount of 0.2 to 3.0% moles
   where % moles are determined with respect to the overall moles of recurring units of polymer (PAS).

Preferably, the polymer (PAS) of the invention comprises:
recurring units (R_{PASp}) in an amount of 88.0 to 95.7% moles;
recurring units (R_{PASo/m}) in an amount of 3.0 to 8.0% moles;
recurring units (R_{PASn}) in an amount of 1.0 to 4.0% moles; and,
recurring units (R_{PASt}) in an amount of 0.3 to 2.0% moles, where % moles are determined with respect to the overall moles of recurring units of polymer (PAS).

More preferably, the polymer (PAS) of the invention comprises:
recurring units (R_{PASp}) in an amount of 89.0 to 94.0% moles;
recurring units (R_{PASo/m}) in an amount of 4.0 to 7.5% moles;
recurring units (R_{PASn}) in an amount of 1.5 to 3.5% moles; and,
recurring units (R_{PASt}) in an amount of 0.5 to 1.5% moles,
   where % moles are determined with respect to the overall moles of recurring units of polymer (PAS).

According to an embodiment of the invention, the polymer (PAS) consists of, or consists essentially of, recurring units (R_{PASp}), (R_{PASo/m}), (R_{PASn}) and, optionally, (R_{PASt}). As said, according to certain other embodiments, the polymer (PAS) consists of, or consists essentially of, recurring units (R_{PASp}), (R_{PASo/m}), (R_{PASn}) and (R_{PASt}). The expression “consists essentially of”, when used in connection with recurring units of polymer (PAS) is intended to mean that minor amounts of spurious recurring units may be tolerated, to the extent they are not significantly modifying the advantageous attributes of polymer (PAS). An amount of less than 1% moles is generally considered as not significantly impacting polymer (PAS)'s attributes.

Recurring units (R_{PAsp}) of polymer (PAS) are preferably recurring units (R_{PPsp}) of formula:

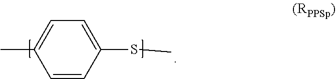

Similarly, recurring units (R_{PASo/m}) of polymer (PAS) are preferably selected from the group consisting of recurring units (R_{PPSo}) and (R_{PPSm}) of formulae:

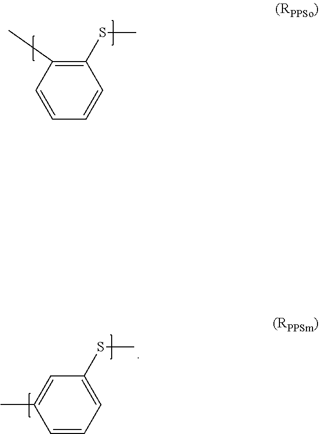

Further, recurring units (R_{PASn}) of polymer (PAS) are preferably recurring units (R_{PPSn}) of any of formulae (R_{PPSn,o}) (R_{PPSn,m}) (R_{PPSn,p}):

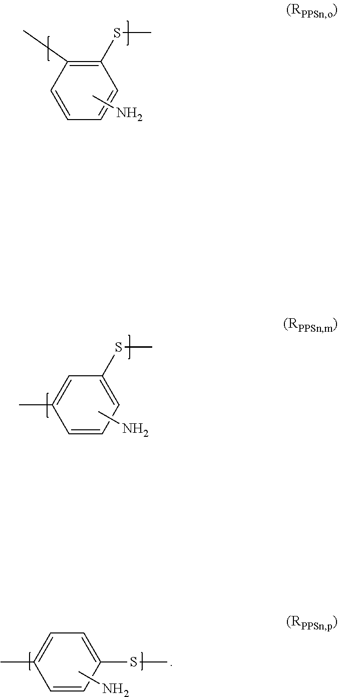

Recurring units as above detailed are units derived from polycondensation reaction of dihaloanilines, in particular from dichloroanilines.

Most preferably, recurring units (R_{PASn}) are recurring units of formula (R_{PPS_TCA}):

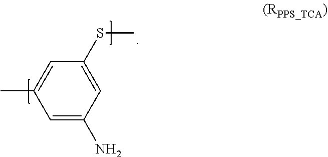

Still, recurring units (R_{PASt}) of polymer (PAS) are preferably recurring units (R_{PPSt}) of formula:

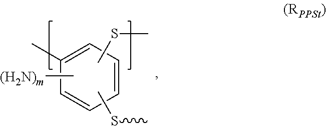

with m being zero or 1, preferably m being zero.

Hence, the polymer (PAS) of the invention is preferably a polyphenylene sulfide polymer [polymer (PPS)] which comprises:
recurring units (R_{PPsp}) in an amount of 85.0 to 97.0% moles;
recurring units (R_{PPSo}) and/or recurring units (R_{PPSm}), the overall amount of recurring units (R_{PPSo}) and recurring units (R_{PPSm}) being of 2.5 to 10.0% moles;
recurring units (R_{PPSn}) in an amount of 0.5 to 5.0% moles; and,
optionally, recurring units (R_{PPSt}) in an amount of zero to 3.0% moles where % moles are determined with respect to the overall moles of recurring units of polymer (PPS).

Preferably, the polymer (PPS) of the invention comprises:
recurring units (R_{PPsp}) in an amount of 88.0 to 96.0% moles;
recurring units (R_{PPSo}) and/or recurring units (R_{PPSm}), the overall amount of recurring units (R_{PPSo}) and recurring units (R_{PPSm}) being of 3.0 to 8.0% moles;
recurring units (R_{PPSn}) in an amount of 1.0 to 4.0% moles; and,
optionally, recurring units (R_{PASt}) in an amount of zero to 2.0% moles, where % moles are determined with respect to the overall moles of recurring units of polymer (PPS).

More preferably, the polymer (PAS) of the invention comprises:
recurring units (R_{PPSp}) in an amount of 89.0 to 94.5% moles;
recurring units (R_{PPSo}) and/or recurring units (R_{PPSm}), the overall amount of recurring units (R_{PPSo}) and recurring units (R_{PPSm}) being of 4.0 to 7.5% moles;
recurring units (R_{PPSn}) in an amount of 1.5 to 3.5% moles; and,
optionally, recurring units (R_{PPSt}) in an amount of zero to 1.5% moles where % moles are determined with respect to the overall moles of recurring units of polymer (PPS).

According to certain embodiments, the polymer (PAS) is preferably a polyphenylene sulfide polymer [polymer (PPS)] which comprises:
recurring units (R_{PPsp}) in an amount of 85.0 to 96.8% moles;
recurring units (R_{PPSo}) and/or recurring units (R_{PPSm}), the overall amount of recurring units (R_{PPSo}) and recurring units (R_{PPSm}) being of 2.5 to 10.0% moles;
recurring units (R_{PPSn}) in an amount of 0.5 to 5.0% moles; and,
recurring units (R_{PPSt}) in an amount of 0.2 to 3.0% moles
   where % moles are determined with respect to the overall moles of recurring units of polymer (PPS).

Preferably, the polymer (PPS) of these embodiments comprises:
recurring units (R_{PPsp}) in an amount of 88.0 to 95.7% moles;
recurring units (R_{PPSo}) and/or recurring units (R_{PPSm}), the overall amount of recurring units (R_{PPSo}) and recurring units (R_{PPSm}) being of 3.0 to 8.0% moles;
recurring units (R_{PPSn}) in an amount of 1.0 to 4.0% moles; and,
recurring units (R_{PASt}) in an amount of 0.3 to 2.0% moles, where % moles are determined with respect to the overall moles of recurring units of polymer (PPS).

More preferably, the polymer (PAS) of these embodiments comprises:
recurring units (R_{PPsp}) in an amount of 89.0 to 94.0% moles;
recurring units (R_{PPSo}) and/or recurring units (R_{PPSm}), the overall amount of recurring units (R_{PPSo}) and recurring units (R_{PPSm}) being of 4.0 to 7.5% moles;
recurring units (R_{PPSn}) in an amount of 1.5 to 3.5% moles; and,
recurring units (R_{PPSt}) in an amount of 0.5 to 1.5% moles
   where % moles are determined with respect to the overall moles of recurring units of polymer (PPS).

Most preferably, in all above listed and preferred polymers (PPS), recurring units (R_{PPSn}) are units of formula (R_{PPS_TCA}).

Preferably, the polymer (PAS) has a weight-average molecular weight (Mw) of at least 25,000 g/mol, more preferably of at least 26,000 g/mol, even more preferably of at least 27,000 g/mol, as determined by gel permeation chromatography.

Preferably, the polymer (PAS) has a weight-average molecular weight (M_{W}) of at most 120,000 g/mol, more preferably of at most 110,000 g/mol, even more preferably of at most 100,000 g/mol, still more preferably of at most 90,000 g/mol, as determined by gel permeation chromatography.

Preferably, the polymer (PAS) has a melting point (Tₘ) of at least 230° C., more preferably of at least 235° C., even more preferably of at least 240° C., when determined on the 2^{nd} heat scan in differential scanning calorimeter (DSC) according to ASTM D3418, using heating and cooling rates of 20° C./min.

Preferably, the polymer (PAS) has a melting point (Tₘ) of at most 265° C., more preferably of at most 264° C., even more preferably of at most 263° C., when determined on the 2^{nd} heat scan in differential scanning calorimeter (DSC) according to ASTM D3418, using heating and cooling rates of 20° C./min.

The polymer (PAS) may advantageously comprise at least one functional group at least one of its chain ends. For instance, the polymer (PAS) may have functional groups at each end of its chain.

When present, the functional groups are according to formula (I) below:

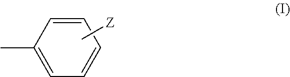

wherein Z is selected from the group consisting of halogen atoms (e.g. chlorine), carboxyl group, amino group, hydroxyl group, thiol group, acid anhydride group, isocyanate group, amide group, and derivatives thereof such as salts of sodium, lithium, potassium, calcium, magnesium, zinc.

Preferably, when present, the functional groups are selected from the group consisting of amino group, hydroxyl group, thiol group, hydroxylate and thiolate.

Such end groups may be appropriately introduced in the polymer (PAS) of the invention through the use of suitable mono-halogenated functional compounds during the manufacture of polymer (PAS) itself, and/or though appropriate chemistry at the end groups.

### Method for the Manufacture of a Poly(Arylene Sulfide) Polymer

As said, in a second aspect, the present invention relates to a method for the manufacture of a poly(arylene sulfide) polymer, in particular for the manufacture of polymer (PAS), as detailed above. The method comprising reacting, in the presence of at least one sulfur compound [compound (SC)], a mixture comprising dihalo compounds X—Arₚ—X′, X″—Ar_{o/m}—X′″, and X′^{v}—Arₙ—X^{v}, as described above.

Possibly, the mixture further comprises at least one tri-halo-compound of formula (II):

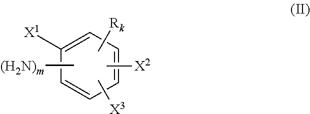

wherein:
R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group;
k, at each instance, is an independently selected integer from 0 to 3;
m, at each instance, is either 1 or zero, preferably m is zero;
each of X¹, X² and X³ is an independently selected halogen, preferably is chlorine or bromine, more preferably is chlorine.

The amounts of the dihalo compounds X—Arₚ—X′, X″—Ar_{o/m}—X′″, and X′^{v}—Arₙ—X^{v}, as described above, and optionally of the tri-halo-compound of formula (II) corresponds to the amounts of the targeted amounts of corresponding recurring units (R_{PASp}), (R_{PASo/m}), (R_{PASn}) and, where appropriate, (R_{PASt}), which have been described above in connection with polymer (PAS).

Hence, as said, the monomer mixture comprises:
dihalo compound X—Arₚ—X′ in an amount of 85.0 to 97.0% moles;
dihalo compound X″—Ar_{o/m}—X′″ in an amount of 2.5 to 10.0% moles; and
dihalo compound X′^{v}—Arₙ—X^{v} in an amount of 0.5 to 5.0% moles,
   where % moles are determined with respect to the overall moles of compounds in the monomer mixture.

In particular, the monomer mixture comprises:
dihalo compound X—Arₚ—X′ in an amount of 85.0 to 97.0% moles;
dihalo compound X″—Ar_{o/m}—X′″ in an amount of 2.5 to 10.0% moles;
dihalo compound X′^{v}—Arₙ—X^{v} in an amount of 0.5 to 5.0% moles; and,
optionally, tri-halo-compound of formula (II) in an amount of zero to 3.0% moles
   where % moles are determined with respect to the overall moles of compounds in the monomer mixture.

Preferably, the monomer mixture comprises:
dihalo compound X—Arₚ—X′ in an amount of 88.0 to 96.0% moles;
dihalo compound X″—Ar_{o/m}—X′″ in an amount of 3.0 to 8.0% moles;
dihalo compound X′^{v}—Arₙ—X^{v} in an amount of 1.0 to 4.0% moles; and,
optionally, tri-halo-compound of formula (II) in an amount of zero to 2.0% moles, where % moles are determined with respect to the overall moles of compounds in the monomer mixture.

More preferably, the monomer mixture comprises:
dihalo compound X—Arₚ—X′ in an amount of 89.0 to 94.5% moles;
dihalo compound X″—Ar_{o/m}—X′″ in an amount of 4.0 to 7.5% moles;
dihalo compound X′^{v}—Arₙ—X^{v} in an amount of 1.5 to 3.5% moles; and,
optionally, tri-halo-compound of formula (II) in an amount of zero to 1.5% moles,
   where % moles are determined with respect to the overall moles of compounds in the monomer mixture.

For embodiments whereas the polymer (PAS) actually comprises recurring units (R_{PASt}), the monomer mixture comprises:
dihalo compound X—Arₚ—X′ in an amount of 85.0 to 96.8% moles;
dihalo compound X″—Ar_{o/m}—X′″ in an amount of 2.5 to 10.0% moles;
dihalo compound X′^{v}—Arₙ—X^{v} in an amount of 0.5 to 5.0% moles; and,
tri-halo-compound of formula (II) in an amount of 0.2 to 3.0% moles where % moles are determined with respect to the overall moles of compounds in the monomer mixture.

Preferably, monomer mixture according to these embodiments comprises:
dihalo compound X—Arₚ—X′ in an amount of 88.0 to 95.7% moles;
dihalo compound X″—Ar_{o/m}—X′″ in an amount of 3.0 to 8.0% moles;
dihalo compound X′^{v}—Arₙ—X^{v} in an amount of 1.0 to 4.0% moles; and,
tri-halo-compound of formula (II) in an amount of 0.3 to 2.0% moles where % moles are determined with respect to the overall moles of compounds in the monomer mixture.

More preferably, the monomers mixture according to these embodiments comprises:
dihalo compound X—Arₚ—X′ in an amount of 89.0 to 94.0% moles;
dihalo compound X″—Ar_{o/m}—X′″ in an amount of 4.0 to 8.0% moles;
dihalo compound X′^{v}—Arₙ—X^{v} in an amount of 1.5 to 4.0% moles; and,
tri-halo-compound of formula (II) in an amount of 0.5 to 1.5% moles where % moles are determined with respect to the overall moles of compounds in the monomer mixture.

In all the embodiments listed above, the first dihalo-compound of formula X—Arₚ—X′ is preferably a para-dihalobenzene, more preferably is para-dichlorobenzene.

In all the embodiments listed above, the second dihalo-compound of formula X″—Ar_{o/m}—X′″ is preferably selected from the group consisting of ortho-dihalobenzenes and meta-dihalobenzenes; and is more preferably selected from the group consisting of ortho-dichlorobenzene and meta-dichlorobenzene.

In all the embodiments listed above, the third dihalo-compound of formula: X′^{v}—Arₙ—X^{v} is preferably a dihaloaniline, and is preferably selected from the group consisting of 3,5-dichloroaniline, 2,5-dichloroaniline, and 2,6-dichloroaniline, with 3,5-dichloroaniline being preferred.

In all the embodiments listed above, the tri-halo-compound of formula (II) is preferably a trihalobenzene, more preferably is 1,2,4-trichlorobenzene.

The sulfur compound (SC) used in the method of the invention is selected from the group consisting of thiosulfates, thioureas, thioamides, elemental sulfur, thiocarbamates, metal disulfides and oxysulfides, thiocarbonates, organic mercaptans, organic mercaptides, organic sulfides, alkali metal sulfides and bisulfides, and hydrogen sulfide. Preferably, the sulfur compound is an alkali metal sulfide. In some embodiments, the alkali metal sulfide is generated in situ from an alkali metal hydrosulfide and an alkali metal hydroxide. For example, Na₂S is a particularly desirable alkali metal sulfide which can be advantageously used as sulfur compound (SC).

Na₂S can be generated in situ from NaSH and NaOH.

The polymerization solvent is selected such that it is a solvent for reaction components at the reaction temperature (discussed below). In some embodiments, the polymerization solvent is a polar aprotic solvent. Examples of desirable polar aprotic solvents include, but are not limited to, hexamethylphosphoramide, tetramethylurea, n,n-ethylenedipyrrolidone, N-methyl-2-pyrrolidone (“NMP”), pyrrolidone, caprolactam, n-ethylcaprolactam, sulfolane, N,N′-dimethylacetamide, and 1,3-dimethyl-2-imidazolidinone. Preferably, the polymerization solvent is NMP. In embodiments, in which the polymerization solvent includes NMP, NMP can react with NaOH to form N-methyl-1,4-aminobutanoate (“SMAB”).

In some embodiments, the reaction components further include a molecular weight modifying agent. The molecular weight modifying agent may contribute to increase the molecular weight of the polymer (PAS), relative to a synthesis scheme not including the molecular weight modifying agent. Preferably, the molecular weight modifying agent is an alkali metal carboxylate. Alkali metal carboxylates are represented by the formula: R′CO₂M′, where R′ is selected from the group consisting of a C₁ to C₂₀ hydrocarbyl group, a C₁ to C₂₀ hydrocarbyl group and a C₁ to C₅ hydrocarbyl group; and M′ is selected from the group consisting of lithium, sodium, potassium, rubidium or cesium. Preferably M′ is sodium or potassium, most preferably sodium. Preferably, the alkali metal carboxylate is sodium acetate.

The method of the invention advantageously comprises reacting the monomer mixture comprising dihalo compounds X—Arₚ—X′, X″—Ar_{o/m}—X′″, and X′^{v}—Arₙ—X^{v}, as described above, and optionally the tri-halo-compound of formula (II), as detailed above, at a reaction temperature selected such that X—Arₚ—X′, X″—Ar_{o/m}—X′″, and X′^{v}—Arₙ—X^{v}, and optionally the tri-halo-compound of formula (II) and SC polymerize to form the polymer (PAS). In some embodiments, the temperature at which the monomer mixture is reacted ranges from 170° C. to 450° C., or from 200° C. to 285° C. The reaction time (aka time duration of the polymerization reaction) can be from 10 minutes to 3 days or from 1 hour to 8 hours. In the method of the invention, during the reaction, the pressure (reaction pressure) is advantageously selected to maintain the monomer mixture and the solvent (when used) in the liquid phase. In some embodiments, the reaction pressure can be from 0 pounds per square inch gauge (“psig”) to 400 psig, from 30 psig to 300 psig, or from 100 psig to 250 psig.

The step of reacting the monomer mixture can be terminated by cooling the product mixture to a temperature at which the polymerization reaction ceases. “Product mixture” refers to the mixture formed during the reaction and contains any remaining unreacted monomer mixture component, formed polymer (PAS) and any reaction by-products. The cooling can be performed using a variety of techniques known in the art. In some embodiments, the cooling can be done by flashing rapidly the reaction mixture. In some embodiments, the cooling can include liquid quenching.

In liquid quenching, a quench liquid is added to the reaction mixture to cool the product mixture. In some embodiments, the quench liquid is selected from the group consisting of the polymerization solvent, water and a combination thereof. In some embodiments, the temperature of the quench liquid can be from about 15° C. to 99° C. In some embodiments, the temperature of the quench liquid can be from 54° C. to 100° C. (e.g. in embodiments in which the quench liquid is the solvent) or from 15° C. to 32° C. (e.g. in embodiments in which the quench liquid is water). The cooling can be further facilitated by use of a reactor jacket or coil, to cool the reaction vessel in which the polymerization reaction is performed (“polymerization reactor”). For clarity, termination of the polymerization reaction does not imply that complete reaction of the reaction components. Generally, termination is initiated at a time when the polymerization reaction is substantially complete or reaches the targeted yield or when further reaction of the reaction components would not result in a significant increase in average molecular weight of the polymer (PAS).

After termination, the polymer (PAS) is generally present in admixture in the product mixture. The product mixture generally further includes water, the solvent, reaction by-products including salts (e.g. sodium chloride and sodium acetate); oligomers, and any unreacted reaction components (collectively, “post-reaction compounds”). Generally, after termination, the product mixture including polymer (PAS) is present as a slurry, having a liquid phase and a solid phase containing the polymer (PAS) (precipitated from the solvent during liquid quenching or during the flashing). In some embodiments, the product mixture including polymer (PAS) can be provided as wet polymer (PAS), for example, by filtration of the slurry after termination.

Subsequent to termination, a recovery process may be implemented. The recovery process includes one or more washes, where each wash includes contacting the polymer (PAS) formed during polymerization reaction with a liquid. The liquid of each wash is independently selected from water, aqueous acid, and an aqueous metal cation solution. Subsequent to the recovery process, the polymer (PAS) can be dried. The drying can be performed at any temperature which can substantially dry the polymer (PAS), to yield a dried polymer (PAS). Desirably, the drying process is selected to help prevent oxidative curing of the polymer (PAS).

For example, if the drying process is conducted at a temperature of at least 100° C., the drying can be conducted in a substantially non-oxidizing atmosphere (e.g., in a substantially oxygen free atmosphere or at a pressure less than atmospheric pressure, for example, under vacuum).

When the drying process is conducted at a temperature less than 100° C., the drying process can be facilitated by performing the drying at a pressure less than atmospheric pressure so the liquid component can be vaporized from the polymer (PAS). When the drying is performed at a temperature of less than 100° C., the presence of a gaseous oxidizing atmosphere (e.g. air) generally does not result in a detectable curing of the polymer (PAS).

### Composition (C) and Method for its Manufacturing

As already said, the present invention also relates to a composition (C) comprising the polymer (PAS), described above and at least one epoxy resin.

Suitable epoxy resin compositions used in the composition (C) include without limitation, epoxy ethers formed by reaction of an epihalohydrin, such as epichlorohydrin, for example, with a polyphenol, typically and preferably in the presence of an alkali. Suitable polyphenols include, for example, catechol, hydroquinone, resorcinol, bis(4-hydroxyphenyl)-2,2-propane (Bisphenol A), bis(4-hydroxyphenyl)-1,1-isobutane, bis(4-hydroxyphenyl)-1,1-ethane, bis(2-hydroxyphenyl)-methane, 4,4-dihydroxybenzophenone, 1, 5-hydroxynaphthalene, and the like. Bisphenol A and the diglycidyl ether of Bisphenol A are preferred.

Suitable epoxy resin may also include polyglicydyl ethers of polyhydric alcohols. These compounds may be derived from polyhydric alcohols such as, for example, ethylene glycol, propylene glycol, butylene glycol, 1,6-hexylene glycol, neopentyl glycol, diethylene glycol, glycerol, trimethylol propane, pentaerythritol, and the like. Other suitable epoxides or polyepoxides include polyglycidyl esters of polycarboxylic acids formed by reaction of epihalohydrin or other epoxy compositions with aliphatic or aromatic polycarboxylic acid such as, for example, succinic acid, adipic acid, azelaic acid, sebacic acid, maleic acid, fumaric acid, phthalic acid, tetrahydrophthalic acid, hexahydrophthalic acid, trimellitic acid, and the like. In an aspect, dimerized unsaturated fatty acids and polymeric polycarboxylic acids can also be reacted to produce polyglycidyl esters of polycarboxylic acids.

In an embodiment, the epoxy resin suitable for use in the composition (C) can be derived by oxidation of an ethylenically unsaturated alicyclic compound. Ethylenically unsaturated alicylic compounds are epoxidized by reaction with oxygen, perbenzoic acid, acid-aldehyde monoperacetate, peracetic acid, and the like. Polyepoxides produced by such reaction are known to those of skill in the art and include, without limitation, epoxy alicylic ethers and esters.

In an embodiment, the epoxy resin includes epoxy novolac resins, obtained by reaction of epihalohydrin with the condensation product of aldehyde and monohydric or polyhydric phenols. Examples include, without limitation, the reaction product of epichlorohydrin with condensation product of formaldehyde and various phenols, such as for example, phenol, cresol, xylenol, butylmethyl phenol, phenyl phenol, biphenol, naphthol, bisphenol A, bisphenol F, and the like.

In an embodiment, the composition (C) is a curable composition that further includes at least one curing agent. In an embodiment, the curing agent described herein helps achieve a composition (C) with a cure time on the order of three minutes or less. The curing agent is generally selected to be compatible with the composition (C) and operate to cure the composition (C) only when melted at the temperature used to cure the composition (C). Suitable curing agents may include dihydrazides prepared by the reaction of carboxylic acid esters with hydrazine hydrate. Such reactions are known to those of skill in the art and produce, for example, carbodihydrazide, oxalic dihydrazide, malonic dihydrazide, ethyl malonic dihydrazide, succinic dihydrazide, glutaric dihydrazide, adipic dihydrazide, pimelic dihydrazide, sebacic dihydrazide, maleic dihydrazide, isophthalic dihydrazide, icosanedioic acid dihydrazide, valine dihydrazide, and mixtures thereof. Of these, adipic acid dihydrazide, sebacic acid dihydrazide, isophthalic dihydrazide, icosanedioic acid dihydrazide, valine dihydrazide are preferred, with sebacic acid dihydrazide particularly preferred.

The composition (C) may also comprise at least one additive, for example in an amount of less than 10 wt. %, said additive being selected from the group consisting of colorants, dyes, pigments, lubricants, plasticizers, flame retardants, nucleating agents, heat stabilizers, light stabilizers, antioxidants, processing aids, fusing agents, electromagnetic absorbers and combinations thereof, wherein the wt. % is based on the total weight of the composition (C).

The composition (C) may also comprise at least one filler different from the additive above. When present, said filler may be present in the composition (C) in an amount of at least 5 wt. %, at least 10 wt. %, at least 15 wt. %, at least 20 wt. %, based on the total weight of the composition (C).

According to various embodiments of the invention, said at least one filler may be present in the composition (C) in an amount of at most 60 wt. %, at most 55 wt. %, at most 50 wt. %, at most 45 wt. %, based on the total weight of the polymer composition (C).

According to various embodiments of the invention, said at least one additional additive may be present in the composition (C) in an amount of less than 5 wt. %, less than 4 wt. %, less than 3 wt. %, less than 2 wt. %, less than 1 wt. %, based on the total weight of the composition (C).

Said at least one filler may be selected from the group consisting of toughening agents and reinforcing agents.

The toughening agents are preferably selected from elastomers. In a preferred embodiment, the toughening agents are present in the composition (C) in an amount up to 30 wt. %, for example up to 25 wt. %, based on the total weight of the composition (C).

The reinforcing agents may be selected from the group consisting of fibrous reinforcing fillers, particulate reinforcing fillers and mixtures thereof. A fibrous reinforcing filler is considered herein to be a material having length, width and thickness, wherein the average length is significantly larger than both the width and the thickness. Generally, a fibrous reinforcing filler has an aspect ratio, defined as the average ratio between the length and the largest of the width and the thickness of at least 5, at least 10, at least 20 or at least 50.

Fibrous reinforcing fillers include glass fibers, carbon or graphite fibers, and fibers formed of silicon carbide, alumina, titania, boron and the like, and may include mixtures comprising two or more such fibers. Non-fibrous reinforcing fillers include notably talc, mica, titanium dioxide, calcium carbonate, potassium titanate, silica, kaolin, chalk, alumina, mineral fillers, and the like.

Preferably, said at least one filler is a fibrous reinforcing filler. Among fibrous reinforcing fillers, glass fibers and carbon fibers are preferred. According to a preferred embodiment of the invention, said composition (C) comprises up to 60 wt. % of glass fibers and/or carbon fibers, for example from 30 to 40 wt. %, based on the total weight of the composition (C).

According to certain embodiments, the composition (C) may be used for formulating composite material solutions.

According to certain embodiments, the composition (C) is a powder coating composition. The powder coating composition is a fusible composition made of loose particles that melts on application of heat to form a coating film. The powder can be applied using methods known to those of skill in the art, such as, for example, electrostatic spray methods, and can be cured to a dry film thickness of about 200 to about 500 microns, preferably 300 to 400 microns.

### Articles and Applications

In an embodiment, the present invention provides a method for coating a substrate using the composition (C) as detailed above.

The use of composition (C) enables combining the advantageous attributes of epoxy resin and polymer (PAS), while achieving a homogeneous and interpenetrated network of coating, through curing of the epoxy resin at a temperature at which polymer (PAS) is able to react in the molten state.

Notably, powder coatings of the type described herein are used on oil and natural gas pipelines, i.e. large diameter pipe made from high grade steel.

In an embodiment, the powder composition is preferably applied to the surface of a substrate, preferably a metal substrate, more preferably a high performance steel substrate. The powder composition is applied using methods known to those of skill in the art, such as, for example, electrostatic spray methods. Prior to application of the powder coating, the substrate is typically and preferably degreased and shot blasted, preferably to a depth of about 50 to 70 μm.

In an embodiment, the methods described herein include applying the powder composition described above to the substrate and curing the composition on the substrate. In an aspect, the powder composition is applied to a substrate by conventional methods such as electrostatic spray, for example. The coated substrate is then heated to allow the powder particles to melt and fuse, followed by curing of the coating at the same temperature.

Should the disclosure of any patents, patent applications, and publications which are incorporated herein by reference conflict with the description of the present application to the extent that it may render a term unclear, the present description shall take precedence.

The invention will now be described with reference to the following examples, whose purpose is merely illustrative and not intended to limit the scope of the invention.

### Experimental Section

### Raw Materials

1-methyl-2-pyrrolidone (“NMP”) (>99.0%): obtained from TCl
sodium hydrosulfide (“NaSH”) (55-60 wt. %): obtained from AkzoNobel
1,4-dichlorobenzene (“DCB”) (≥99): obtained from Alfa Aesar
1,3-dichlorobenzene (“mDCB”) (≥99): obtained from Alfa Aesar
sodium hydroxide (≥97.0%): obtained from Fisher Chemical
sodium acetate (≥99%): obtained from VWR Chemicals
3,5-dichloroaniline (“DCA”) (98%): obtained from Alfa Aesar
1,2,4-trichlorobenzene (“TCB”) (99%): obtained from Alfa Aesar
3,3′,4,4′-biphenyltetracarboxylic dianhydride (“BPDA”) (97%): obtained from Sigma

### Characterizations

The extrusion rate referred to as the “1270ER” was generally measured by the method of ASTM D 1238-86, Procedure B-Automatically Timed Flow Rate Procedure, Condition 316/5.0. The orifice was 0.0825+/−0.002 inches in diameter, and 1.25 inch in length, using a total drive weight, including the piston, of 1270 grams, and the temperature used was 316° C., with a 5 minute pre-heat time prior to the measurement. The values for 1270ER are expressed as grams per ten minutes (g/10 min). The extrusion rate referred to as the “MFR” was conducted using a total drive weight of 5000 g using a die with a 0.0825+/−0.002 inch orifice and a 0.315 inch length.

Molecular weight was determined by Gel Permeation Chromatography from amorphous pressed film samples at 210° C. using an Agilent PL220 HT-GPC with a 1-chloronaphthalene mobile phase and polystyrene standards.

Melting point was determined by DSC, according to ASTM D3418 standard. Samples were heated to 350° C. and held for 5 minutes to erase any thermal history, cooled to 30° C., and heated to 350° C. again, all at a rate of 20° C. per minute.

### Synthesis

### Example 1: (2.5 Mol % DCA/5 Mol % mDCB Terpolymer)

Resin synthesis: A 1-L autoclave reactor was charged with 34.50 g sodium hydroxide (0.863 mol), 22.89 g sodium acetate (0.279 mol), 79.78 g NaSH (59.43 wt %, 0.846 mol), and 234 g NMP. The reactor was purged and pressurized to 10 psig with nitrogen and set to stir continuously at 400 rpm. A separate addition vessel was charged with 115.00 g DCB (0.782 mol), 3.43 g DCA (0.021 mol), 6.22 g mDCB (0.042 mol), and 50 g NMP.

The addition vessel was purged and pressurized to 90 psig with nitrogen, and heated to 100° C. The reactor was heated from room temperature at 1.5° C./min. Upon reaching 150° C., the reactor was vented through a condenser and 46 mL of a clear condensate was collected under a small stream of nitrogen (60 mL/min) until the reactor reached 200° C. At this point, the condenser was removed, the nitrogen flow was stopped, and the DCB/DCA/mDCB/NMP mixture in the addition vessel was promptly added to the reactor. The addition vessel was charged with an additional 30 g NMP, purged and pressurized to 90 psig with nitrogen, and the contents were immediately added to the reactor. The sealed reactor continued heating to 240° C. and was then held at 240° C. for 2 hours, heated to 265° C. at 1.5° C./min, and held at 265° C. for 2 hours. At this point, a mixture of 15.8 g water and 7.5 g NMP were added to the reactor under 250 psig pressure. The reactor contents were then cooled to 200° C. at 1.0° C./min, and finally allowed to cool to room temperature. The resulting slurry was diluted with 200 mL NMP, removed from the reactor, heated to 80° C. and screened on a No. 120 sieve (125 μm openings). The solids were rinsed with an additional 100 mL warm NMP (60° C.). Then, the solids were transferred to a separate vessel, stirred for 15 minutes in 300 mL heated DI water (70° C.), and screened on the No. 120 sieve, a process that was repeated five times in total. The rinsed solids were dried in a vacuum oven overnight at 100° C. under nitrogen, affording 60.49 g of a white granular resin. 1270ER=102 g⋅(10 min)⁻¹·M_{w}=27,000 g/mol. Tₘ=263° C.

Reactive extrusion with BPDA to test amine reactivity: In a DSM Xplore 15 cc twin-screw microcompounder, 12 g of the polymer obtained as above detailed were mixed with 407 mg BPDA for 10 minutes with a screw speed of 100 rpm and a barrel temperature of 335° C. The resulting yellow-brown extrudate had an MFR of 0, indicative of major cross-linking; this was further evidence of the presence of bound amine group in the polymer.

BPDA, i.e. 3,3′,4,4′-biphenyl-tetracarboxylic dianhydride, was so shown to form an imide cross-link between amine sites of the polymer obtained, leading to the measured substantial reduction of melt flow rate (MFR) in the polymer.

### Example 2: (2.5 Mol % DCA/7.5 Mol % mDCB Terpolymer)

Resin synthesis: Synthesized according to procedure from Example 1 but in a 400-L reactor with 31.23 kg sodium hydroxide solution (50.40 wt %, 394 mol), 12.13 kg sodium acetate (148 mol), 41.56 kg NaSH (56.62 wt %, 420 mol), 53.18 kg DCB (362 mol), 1.63 kg DCA (10 mol), 4.43 kg mDCB (30 mol), and 123.47 kg total NMP. Reaction afforded 25.17 kg of a white powdery resin. 1270ER=54 g⋅(10 min)⁻¹·M_{w}=34,000 g/mol. Tₘ=258° C.

Reactive extrusion with BPDA to test amine reactivity: In a DSM Xplore 15 cc twin-screw microcompounder, 12 g of the polymer obtained as above indicated was mixed with 407 mg BPDA for 10 minutes with a screw speed of 100 rpm and a barrel temperature of 335° C. The resulting yellow-brown extrudate had an MFR of 21, indicative of significant cross-linking; this was further evidence of the presence of bound amine group in the polymer.

### Example 3: (2.5 Mol % DCA/10 Mol % mDCB Terpolymer)

Resin synthesis: Synthesized according to procedure from Example 1 with 33.69 g sodium hydroxide (0.842 mol), 22.36 g sodium acetate (0.273 mol), 77.91 g NaSH (59.43 wt %, 0.826 mol), 106.23 g DCB (0.723 mol), 3.35 g DCA (0.021 mol), 12.14 g mDCB (0.083 mol), and 307 g total NMP. Reaction afforded 42.78 g of a white granular resin. 1270ER=183 g ⋅(10 min)⁻¹·M_{w}=25,000 g/mol. Tₘ=248° C.

Reactive extrusion with BPDA to test amine reactivity: In a DSM Xplore 15 cc twin-screw microcompounder, 12 g of the polymer as above indicated was mixed with 407 mg BPDA for 10 minutes with a screw speed of 100 rpm and a barrel temperature of 335° C. The resulting yellow-brown extrudate had an MFR of 0.66, indicative of major cross-linking; this was further evidence of the presence of bound amine group in the polymer.

### Example 4: (2.5 Mol % DCA/7.5 Mol % mDCB/0.8% TCB Tetrapolymer)

Resin synthesis: Synthesized according to procedure from Example 1 with 31.82 g sodium hydroxide (0.796 mol), 21.11 g sodium acetate (0.257 mol), 76.78 g NaSH (56.95 wt %, 0.780 mol), 103.19 g DCB (0.702 mol), 3.16 g DCA (0.019 mol), 8.60 g mDCB (0.058 mol), 1.132 g TCB (0.006 mol), and 290 g total NMP. Reaction afforded 77.17 g of a white granular resin. 1270ER=20 g⋅(10 min)⁻¹·M_{w}=42,000 g/mol. Tₘ=248° C.

Reactive extrusion with BPDA to test amine reactivity: In a DSM Xplore 15 cc twin-screw microcompounder, 12 g of the polymer as above indicated was mixed with 407 mg BPDA for 10 minutes with a screw speed of 100 rpm and a barrel temperature of 335° C. The resulting yellow-brown extrudate had an MFR of 0, indicative of major cross-linking; this was further evidence of the presence of bound amine group in the polymer.

### Comparative Example 1: (2.5 Mol % DCA Copolymer)

Resin synthesis: Synthesized according to procedure from Example 1 (except that polymer was isolated on a medium porosity fritted funnel instead of a sieve) with 33.40 g sodium hydroxide (0.835 mol), 22.17 g sodium acetate (0.270 mol), 80.35 g NaSH (57.13 wt %, 0.819 mol), 117.35 g DCB (0.798 mol), 3.32 g DCA (0.020 mol), and 304 g total NMP. Reaction afforded 81.9 g of a white powdery resin. 1270ER=147 g ⋅(10 min)⁻¹·M_{W}.=23,000 g/mol. Tₘ, =280° C.

Reactive extrusion with BPDA to test amine reactivity: In a DSM Xplore 15 cc twin-screw microcompounder, 12 g of the polymer as above indicated was mixed with 407 mg BPDA for 10 minutes with a screw speed of 100 rpm and a barrel temperature of 335° C. The resulting yellow-brown extrudate had an MFR of 0.41, indicative of major cross-linking; this was further evidence of the presence of bound amine group in the polymer.

### Comparative Example 2: (5 Mol % DCA Copolymer)

Resin synthesis: Synthesized according to procedure from Example 1 (except that polymer was isolated on a medium porosity fritted funnel instead of a sieve) with 32.16 g sodium hydroxide (0.804 mol), 21.34 g sodium acetate (0.260 mol), 77.35 g NaSH (57.13 wt %, 0.788 mol), 110.08 g DCB (0.749 mol), 6.38 g DCA (0.039 mol), and 293 g total NMP.

Reaction afforded 79.21 g of a white powdery resin. 1270ER=793 g ⋅(10 min)⁻¹·M_{w}=16,000 g/mol. Tₘ=276° C.

Reactive extrusion with BPDA to test amine reactivity: In a DSM Xplore 15 cc twin-screw microcompounder, 12 g of the resin was mixed with 810 mg BPDA for 10 minutes with a screw speed of 100 rpm and a barrel temperature of 335° C. The resulting yellow-brown extrudate had an MFR of 0, indicative of major cross-linking; this is a further evidence of the presence of bound amine group in the polymer.

### Comparative Example 3: (10 Mol % DCA Copolymer)

Resin synthesis: Synthesized according to procedure from Example 1 (except that polymer was isolated on a medium porosity fritted funnel instead of a sieve) with 32.29 g sodium hydroxide (0.807 mol), 21.43 g sodium acetate (0.261 mol), 77.67 g NaSH (57.13 wt %, 0.792 mol), 104.71 g DCB (0.712 mol), 12.82 g DCA (0.079 mol), and 294 g total NMP. Reaction afforded 82.73 g of a white powdery resin. The 1270ER could not be measured and was >10,000. M_{w}=7,000 g/mol. Tₘ=256° C.

Reactive extrusion with BPDA to test amine reactivity: In a DSM Xplore 15 cc twin-screw microcompounder, 12 g of the polymer obtained as indicated above was mixed with 1.61 g BPDA for 10 minutes with a screw speed of 100 rpm and a barrel temperature of 335° C. The resulting yellow-brown extrudate had an MFR of 0, indicative of major cross-linking; this is a further evidence of the presence of bound amine group in the polymer.

DSC data was obtained from amorphous film samples by heating to 350° C., holding for 5 minutes, cooling to 30° C., and heating to 350° C. again, all at 20° C. per minute. The MFR melt flow index was measured on an extrusion plastometer at 315.6° C. using a 5.00 kg weight and a 0.0825 inch×0.315 inch die. The 1270ER melt flow index was measured on an extrusion plastometer at 315.6° C. using a 1.27 kg weight and a 0.0825 inch×1.25 inch die.

1. A poly(arylene sulfide) polymer [polymer (PAS)] having a weight-averaged molecular weight, as determined by gel-permeation chromatography, of at least 24,000, said polymer (PAS) comprising:
recurring units (R_{PASp}) represented by the following formula:
[—Arₚ—S—] (R_{PASp})
wherein
—Arₚ— is 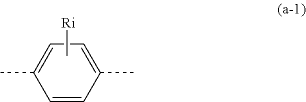
in an amount of 85.0 to 97.0% moles;
recurring units (R_{PASo/m}) represented by the following formula:
[—Ar_{o/m}—S—] (R_{PASo/m})
wherein
—Ar_{p/m}— is any of 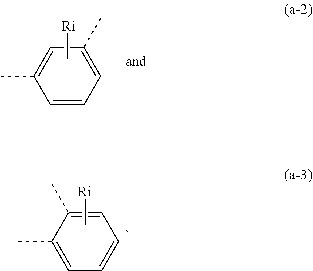
in an amount of 2.5 to 10.0% moles; and
recurring units (R_{PASn}) represented by the following formula:
[—Arₙ—S—] (R_{PASn})
wherein
—Arₙ— is 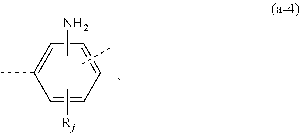
in an amount of 0.5 to 5.0% moles,
wherein:
% moles are determined with respect to the overall moles of recurring units of polymer (PAS);
R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group;
i, at each instance, is an independently selected integer from 0 to 4;
j, at each instance, is an independently selected integer from 0 to 3.

2. The polymer (PAS) according to claim 1, said polymer (PAS) comprising:
recurring units (R_{PASp}) in an amount of 85.0 to 97.0% moles;
recurring units (R_{PASo/m}) in an amount of 2.5 to 10.0% moles;
recurring units (R_{PASn}) in an amount of 0.5 to 5.0% moles; and,
optionally, recurring units (R_{PASt}) in an amount of zero to 3.0% moles where % moles are determined with respect to the overall moles of recurring units of polymer (PAS); and said polymer (PAS) preferably comprising:
recurring units (R_{PASp}) in an amount of 88.0 to 96.0% moles;
recurring units (R_{PASo/m}) in an amount of 3.0 to 8.0% moles;
recurring units (R_{PASn}) in an amount of 1.0 to 4.0% moles; and,
optionally, recurring units (R_{PASt}) in an amount of zero to 2.0% moles, where % moles are determined with respect to the overall moles of recurring units of polymer (PAS); and said polymer (PAS) more preferably comprising:
recurring units (R_{PASp}) in an amount of 89.0 to 94.5% moles;
recurring units (R_{PASo/m}) in an amount of 4.0 to 7.5% moles;
recurring units (R_{PASn}) in an amount of 1.5 to 3.5% moles; and,
optionally, recurring units (R_{PASt}) in an amount of zero to 1.5% moles, where % moles are determined with respect to the overall moles of recurring units of polymer (PAS).

3. The polymer (PAS) according to claim 1, whereas the polymer (PAS) further comprises recurring units (RPAS of formula:
[—Arₜ—S—] (R_{PASt})
where —Arₜ— is 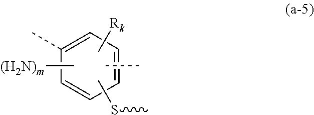
wherein:
R, at each instance, is independently selected from the group consisting of a C1-C12 alkyl group, a C7-C24 alkylaryl group, a C7-C24 aralkyl group, a C6-C24 arylene group, and a Ce—C aryloxy group;
k, at each instance, is an independently selected integer from 0 to 3;
m, at each instance, is either 1 or zero.

4. The polymer (PAS) according to claim 3, wherein the polymer (PAS) comprises:
recurring units (R_{PASp}) in an amount of 85.0 to 96.8% moles;
recurring units (R_{PASo/m}) in an amount of 2.5 to 10.0% moles;
recurring units (R_{PASn}) in an amount of 0.5 to 5.0% moles; and,
recurring units (R_{PASt}) in an amount of 0.2 to 3.0% moles where % moles are determined with respect to the overall moles of recurring units of polymer (PAS); and wherein preferably, the polymer (PAS) comprises:
recurring units (R_{PASP}) in an amount of 88.0 to 95.7% moles;
recurring units (R_{PASo/m}) in an amount of 3.0 to 8.0% moles;
recurring units (R_{PASn}) in an amount of 1.0 to 4.0% moles; and,
recurring units (R_{PASt}) in an amount of 0.3 to 2.0% moles, where % moles are determined with respect to the overall moles of recurring units of polymer (PAS); and wherein more preferably, the polymer (PAS) comprises:
recurring units (R_{PASp}) in an amount of 89.0 to 94.0% moles;
recurring units (R_{PASo/m}) in an amount of 4.0 to 7.5% moles;
recurring units (R_{PASn}) in an amount of 1.5 to 3.5% moles; and,
recurring units (R_{PASt}) in an amount of 0.5 to 1.5% moles, where % moles are determined with respect to the overall moles of recurring units of polymer (PAS).

5. The polymer (PAS) according to claim 3, wherein the polymer (PAS) consists of, or consists essentially of, recurring units (R_{PASp}), (R_{PASo/m}), (R_{PASn}) and, optionally, (R_{PASt}) or the polymer (PAS) consists of, or consists essentially of, recurring units (R_{PASp}), (R_{PASo/m}), (R_{PASn}) and (R_{PASt}).

6. The polymer (PAS) according to claim 3, wherein:
recurring units (R_{PASp}) are recurring units (R_{PPSp}) of formula: 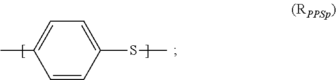
and/or
recurring units (R_{PASo/m}) are selected from the group consisting of recurring units (R_{PPSo}) and (R_{PPSm}) of formulae: 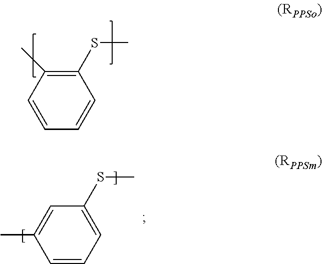
and/or
recurring units (R_{PASn}) are recurring units (R_{PPSn}) of any of formulae (R_{PPSn,o}) (R_{PPSn,m}) (R_{PPSn,p}): 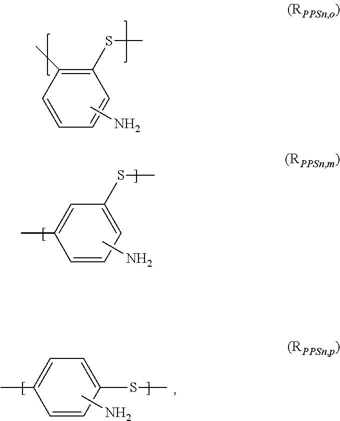
and/or
recurring units (R_{PASn}) are recurring units of formula (R_{PPS_TCA}): 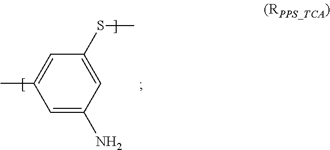
and/or
recurring units (R_{PASt}) are recurring units (R_{PPSt}) of formula: 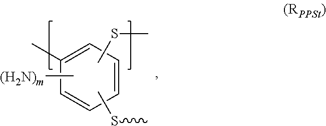
with m being zero or 1, preferably m being zero.

7. The polymer (PAS) according to claim 1,
wherein the polymer (PAS) has a weight-average molecular weight (M_{w}) of at least 25,000 g/mol, more preferably of at least 26,000 g/mol, even more preferably of at least 27,000 g/mol; and/or the polymer (PAS) has a weight-average molecular weight (M_{w}) of at most 120,000 g/mol, more preferably of at most 110,000 g/mol, even more preferably of at most 100,000 g/mol, still more preferably of at most 90,000 g/mol, whereas the M_{w} is determined by gel permeation chromatography; and/or
wherein the polymer (PAS) has a melting point (Tₘ) of at least 230° C., more preferably of at least 235° C., even more preferably of at least 240° C.; and/or the polymer (PAS) has a melting point (Tₘ) of at most 265° C., more preferably of at most 264° C., even more preferably of at most 263° C., whereas the Tₘ is determined on the 2^{nd} heat scan in differential scanning calorimeter (DSC) according to ASTM D3418, using heating and cooling rates of 20° C./min.

8.-11. (canceled)

12. A composition (C) comprising a poly(arylene sulfide) polymer [polymer (PAS)] and at least one epoxy resin, the polymer (PAS) having a weight-averaged molecular weight, as determined by gel-permeation chromatography, of at least 24,000, said polymer (PAS) comprising:
recurring units (R_{PASp}) represented by the following formula:
[—Arₚ—S—] (R_{PASp})
wherein
—Arₚ— is 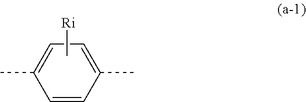
in an amount of 85.0 to 97.0% moles;
recurring units (R_{PASo/m}) represented by the following formula:
[—Ar_{o/m}—S—] (R_{PASo/m})
wherein
—Ar_{p/m}— is 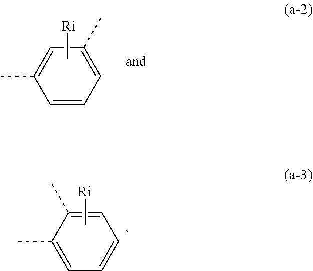
in an amount of 2.5 to 10.0% moles; and
recurring units (R_{PASn}) represented by the following formula:
[—Arₙ—S—] (R_{PASn})
wherein
—Arₙ— 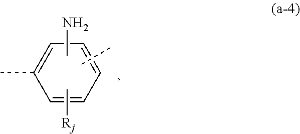
in an amount of 0.5 to 5.0% moles,
wherein:
% moles are determined with respect to the overall moles of recurring units of polymer (PAS);
R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group;
i, at each instance, is an independently selected integer from 0 to 4;
i, at each instance, is an independently selected integer from 0 to 3.

13. The composition (C) according to claim 12, wherein the epoxy resin is selected from the group consisting of:
epoxy ethers formed by reaction of an epihalohydrin, such as epichlorohydrin, for example, with a polyphenol, typically and preferably in the presence of an alkali, whereas the polyphenols include catechol, hydroquinone, resorcinol, bis(4-hydroxyphenyl)-2,2-propane (Bisphenol A), bis(4-hydroxyphenyl)-1,1-isobutane, bis(4-hydroxyphenyl)-1,1-ethane, bis(2-hydroxyphenyl)-methane, 4,4-dihydroxybenzophenone, 1, 5-hydroxynaphthalene;
polyglicydyl ethers of polyhydric alcohols derived from polyhydric alcohols including ethylene glycol, propylene glycol, butylene glycol, 1,6-hexylene glycol, neopentyl glycol, diethylene glycol, glycerol, trimethylol propane, pentaerythritol and polyglycidyl esters of polycarboxylic acids formed by reaction of epihalohydrin or other epoxy compositions with aliphatic or aromatic polycarboxylic acid including succinic acid, adipic acid, azelaic acid, sebacic acid, maleic acid, fumaric acid, phthalic acid, tetrahydrophthalic acid, hexahydrophthalic acid, trimellitic acid;
epoxy resins derived by oxidation of an ethylenically unsaturated alicyclic compound;
epoxy novolac resins, obtained by reaction of epihalohydrin with the condensation product of aldehyde and monohydric or polyhydric phenols.

14. The composition according to claim 12, wherein the composition (C) further includes at least one curing agent, which is preferably selected from the group consisting of dihydrazides prepared by the reaction of carboxylic acid esters with hydrazine hydrate, including preferably carbodihydrazide, oxalic dihydrazide, malonic dihydrazide, ethyl malonic dihydrazide, succinic dihydrazide, glutaric dihydrazide, adipic dihydrazide, pimelic dihydrazide, sebacic dihydrazide, maleic dihydrazide, isophthalic dihydrazide, icosanedioic acid dihydrazide, valine dihydrazide, and mixtures thereof.

15. (canceled)
